(19) United States
(12) Patent Application Publication
(10) Pub. No.: US 2026/0127657 A1
(43) Pub. Date: May 7, 2026

(54) UNIFIED SHOPPING AND CHECKOUT SYSTEM AND METHOD FOR A MULTIPLE MERCHANT E-COMMERCE PLATFORM

(71) Applicants: Nicholas Cabrera, Hialeah, FL (US); Sergio Velazquez, Tamarac, FL (US)

(72) Inventors: Nicholas Cabrera, Hialeah, FL (US); Sergio Velazquez, Tamarac, FL (US)

(21) Appl. No.: 19/381,750

(22) Filed: Nov. 6, 2025

Related U.S. Application Data
(60) Provisional application No. 63/716,930, filed on Nov. 6, 2024.

(51) Int. Cl. G06Q 30/0601

(52) U.S. Cl. CPC G06Q 30/06333; G06Q 30/0641

(57) ABSTRACT

A unified shopping and checkout system and method for a multiple merchant e-commerce platform which allows a buyer on a multiple merchant e-commerce platform to simultaneously complete a wide variety of types of transactions through a combined shopping interface, a cart building engine, and a unified checkout interface. The combined shopping interface includes both products and live bookings from many different merchants and allows them to be browsed, compared, and selected. The cart building engine allows for the aggregation of both products and live bookings into a single transaction by, in part, providing for the provision of the information needed to prior to allowing for the purchase of all selected products and/or bookings in a single transaction, and then provides for the use the information and funds provided during the transaction to complete corresponding transactions for the products and booking selected by the user, with the selected merchants.

### CROSS REFERENCE TO RELATED APPLICATIONS

This application claims the benefit of and incorporates by reference co-pending U.S. provisional patent application Ser. No. 63/716,930 filed Nov. 6, 2024.

### BACKGROUND OF THE INVENTION

### Field of the Invention

This invention relates generally to e-commerce platforms and, more particularly, to a unified shopping and checkout process and interface for a multiple merchant e-commerce platform.

### Description of the Prior Art

The use of electronic commerce (or “e-commerce”) technologies to enable the buying and selling of goods and services over the Internet is well established. E-commerce itself is a relatively new activity, but it has quickly gained wide acceptance and has allowed for significant improvements in efficiency in terms of shopping and fulfillment. As a result, sellers of goods and services in many industries have raced to establish and grow their online presence in order to sell their products and services through e-commerce. At the same time, a growing number of prospective buyers routinely explore and engage with e-commerce options when in the market for desired goods and services.

The large number of buyers and sellers engaging in e-commerce has led to a rise and proliferation of e-commerce platforms, which provide online marketplaces that allow many sellers to offer goods and services for purchase through online shopping transactions, and allow buyers and potential buyers to search, view, and purchase such goods and services. While such existing e-commerce platforms have been able to bring many different buyers and sellers together and allow buyers to shop and purchase different types of products from different merchants (such as Walmart®, Amazon®, Shopify®) on one hand, and allow buyers to shop and purchase different types of bookings from different merchants (such as Expedia®, Uber®, Instacart®) on the other, the ability to efficiently buy products and make bookings together has remained elusive. Accordingly, there remains a need for improved shopping and checkout for a multiple merchant e-commerce platform which provides for, through a combined shopping interface, a cart building engine which can aggregate product listing purchases and live bookings from varying merchants for a single transaction. It would be desirable for such a unified shopping and checkout system for a multiple merchant e-commerce platform to maintain a real time connection with a server for each such merchant in order to enable the identification of the user information required for a desired transaction type in real time. It would additionally be desirable for such a unified shopping and checkout system for a multiple merchant e-commerce platform to, through a unified checkout interface, prompt and require the provision of all required user information for such purchases and bookings, and then utilize the same when completing transactions with relevant merchants.

### SUMMARY OF THE INVENTION

The present disclosure relates to a unified shopping and checkout mechanism system, comprising: an administrator computer system accessible over a computer network, wherein the administrator computer system is configured to: provide a shopping interface which includes a listing containing a plurality of product listing purchasable items available to purchase and a plurality of live booking purchasable items available to purchase, with the plurality of product listing purchasable items and the plurality of live booking purchasable items being retrieved from a plurality of merchant computer systems; receive from a remote client device a product selection defined by a desired product listing purchasable item among the plurality of product listing purchasable items and perform an add to cart process upon receipt of the product selection; receive from the remote client device a booking selection defined by a desired booking purchasable item among the plurality of live booking purchasable items and perform the add to cart process upon receipt of the booking selection; wherein the add to cart process for the product selection includes at least identifying a corresponding product merchant computer system among the plurality of merchant computer systems on which the product selection is offered, identifying product purchaser user information for the product selection required by the corresponding product merchant computer system, attempting to place a checkout hold on the product selection in the corresponding product merchant computer system, and placing the product selection in a checkout queue; wherein the add to cart process for the booking selection includes at least identifying a corresponding booking merchant computer system among the plurality of merchant computer systems on which the booking selection is offered, identifying booking purchaser user information for the booking selection required by the corresponding booking merchant computer system, creating a temporary substitute product selection that is associated with the booking selection, placing the substitute product selection in the checkout queue and by doing so, place a checkout hold on the booking selection in the corresponding booking merchant computer system; and subsequent to the add to cart process for the booking selection, create a checkout interface related to the checkout queue, wherein the checkout interface enables the entry by the remote client device of the product purchaser user information and the booking purchaser user information and the initiation by the remote client device of a unified payment for the product selection in the checkout queue and the booking selection associated with the substitute product selection in the checkout queue.

It is an object of the present disclosure to provide a unified shopping and checkout system for a multiple merchant e-commerce platform which provides for, through a combined shopping interface, a cart building engine which can aggregate product listing purchases and live bookings from varying merchants for a single transaction.

It is another object of the present disclosure to provide a unified shopping and checkout system for a multiple merchant e-commerce platform which maintains a real time connection with a server for each such merchant in order to enable the identification of the user information required for a desired transaction type in real time.

It is yet another object of the present disclosure to provide a unified shopping and checkout system for a multiple merchant e-commerce platform which, through a unified checkout interface, prompts and requires the provision of all required user information for such purchases and bookings, and then utilizes the same when completing transactions with relevant merchants.

### BRIEF DESCRIPTION OF THE DRAWINGS

FIG. 1 is a schematic diagram showing the operative components involved in a unified shopping and checkout system and method for a multiple merchant e-commerce platform built in accordance with the present invention.

FIG. 2 is a screenshot of a combined shopping interface for a unified shopping and checkout system and method for a multiple merchant e-commerce platform built in accordance with the present invention.

FIG. 3 is a screenshot of a unified checkout interface for a unified shopping and checkout system and method for a multiple merchant e-commerce platform built in accordance with the present invention.

FIGS. 4a and 4b show the checkout steps of a unified shopping and checkout system and method for a multiple merchant e-commerce platform in accordance with the present invention.

### DETAILED DESCRIPTION OF THE INVENTION

Described herein is a system and method which provides a unified shopping and checkout mechanism which allows a buyer on a multiple merchant e-commerce platform to simultaneously complete a wide variety of types of transactions. The unified shopping and checkout system and method for a multiple merchant e-commerce platform described herein provides a combined shopping interface which allows users to search and view not just products from many different merchants, but also bookings from many different merchants (bookings as in, by way of example, airline tickets or hotel rooms), and then also to transact with one or several of such merchants by engaging in a single transaction through the unified checkout interface. In this regard, when a user selects products and/or bookings from a plurality of merchants that the user seeks to transact with through the combined shopping interface, a cart building engine provides for the identification of what information is required to complete the particular desired transaction with each relevant merchant and the provision by the user of such information prior to allowing for the completion of the transaction on the unified checkout interface. Once the user completes the transaction as required by the unified checkout interface, the system and method uses the information and funds provided during the user transaction to complete corresponding transactions for the products and booking selected by the user, with the merchants selected by the user.

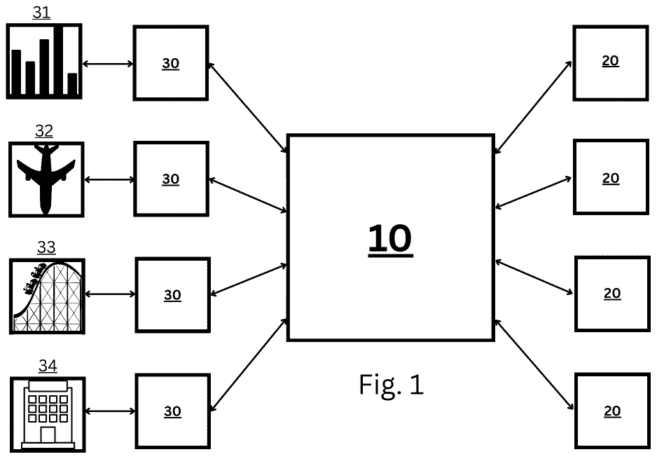

Referring now to the drawings and, in particular, FIG. 1, a unified shopping and checkout system and method for a multiple merchant e-commerce platform may be deployed through a platform server 10 which operates the e-commerce platform which operates in accordance with the present invention. In this regard, it is appreciated that the platform server 10 may operate as an administrator computer system, comprise one or more dedicated or shared server resources and include one or multiple databases, and be connected to one or multiple computer networks, such as the Internet. The platform server 10 may be accessible by a plurality of client devices 20 which may be used by customers and potential customers to engage in online shopping. The platform server 10 may also have access to a plurality of merchant servers 30 which may have set up an online store through the platform server 10 where items can be sold. It is appreciated that the platform server 10, through its connection to a computer network like the Internet, may be operative to connect to and send and/or receive data with various computer systems which are accessible over the Internet, which may include the plurality of client devices 20 and the merchant servers 30.

As merchants (alternatively referred to herein as “sellers”) with an online store on the e-commerce platform operated through the platform server 10, it is contemplated that the merchant server 30 of a given seller may operate in conjunction with an offsite warehouse 31, an airline terminal 32, a retail business storefront 33, or a hotel 34 (or any other facility and may cause such physical items to be directly sent to a purchaser, provide services to a user, or be available for purchase through an e-commerce transaction). It is further contemplated that while in some embodiments a given seller who operates a merchant server 30 for goods that may be stored and/or shipped may operate or control the storage and fulfillment operations of such a warehouse 31 or retail business storefront 33, in other embodiments an operator of the platform server 10 may operate or control the storage and fulfillment operations of such a warehouse 31 or a retail business storefront 33.

It is appreciated that generally, many of the merchants who may operate a merchant server 30 may do so in conjunction with the offering of product listings or in conjunction with live bookings. To accommodate either of such merchants, the platform server 10 may provide distinct onboarding systems for product listing merchants and for live booking merchants. For example, a product listing onboarding system may include product catalog integration, where each merchant's products are imported so as to be uniquely listed, and inventory and stock management integration which includes creating stock synchronizing interface which allows merchant inventory levels to be monitored by the platform server 10. Similarly, a live booking onboarding system may include a booking integration which includes creating a booking synchronizing interface which provides the platform server 10 with access to live feeds for bookings available to be purchased through a given merchant, such as hotels, flights, food/restaurants, groceries, transportation, and entertainment.

In any event, it may be through one or more interfaces provided to client devices 20 by the platform server 10, a given seller may make goods or bookings available for viewing and purchasing by interfacing with the merchant server 30, and it may be through one or more interfaces provided by the platform server 10 that users of client devices 20 may search for, view, and purchase goods or services made available by a given seller. It is contemplated that in many scenarios, the platform server 10 and given merchant servers 30 may interface and communicate on the details on items to be sold (including a price set by the seller), requirements for selling items, item sales, and fulfilling the sale of items through an application programming interface.

Embodiments of the combined shopping interface may include a display management system which, when multiple merchants offer the same product, links the products in the combined shopping interface so as to allow price comparisons to occur on the same screen. Advantageously, this aspect of the display management system may allow users to select the best prices and can avoid deceptive ads. It is appreciated that existing approaches often allow for online arbitrage, where a user can purchase a product from a first vendor for a first price and then resell that same product on a second vendor for a second, higher price if that second vendor's listed price is higher than the first price. In addition, the display management system may include a premium option which operates to allow a user to cause items to be listed on the combined shopping interface to list products in ascending order by price, overriding any advantageous placement that is based on ad spend or some other behind the scenes factor. It is appreciated that this premium option could allow a user to save money and by being able to immediately identify who really has the cheapest price for an item.

It is appreciated that the combined shopping interface may also tag each product being sold therein with the merchant selling it, and the display management system may use this tag to allow for a “shop by store” filter to be applied by a user.

The operation of these aspects of the display management system could be exemplified by a user looking up “baby stroller” and placing a Walmart® and Amazon® filter on, all in the combined shopping interface. The display management system would then cause the combined shopping interface to show the searched for stroller at Walmart® with its listed price and at Amazon® with its listed price. Advantageously, this would allow users to quickly order from who has the best price between their favorite merchant.

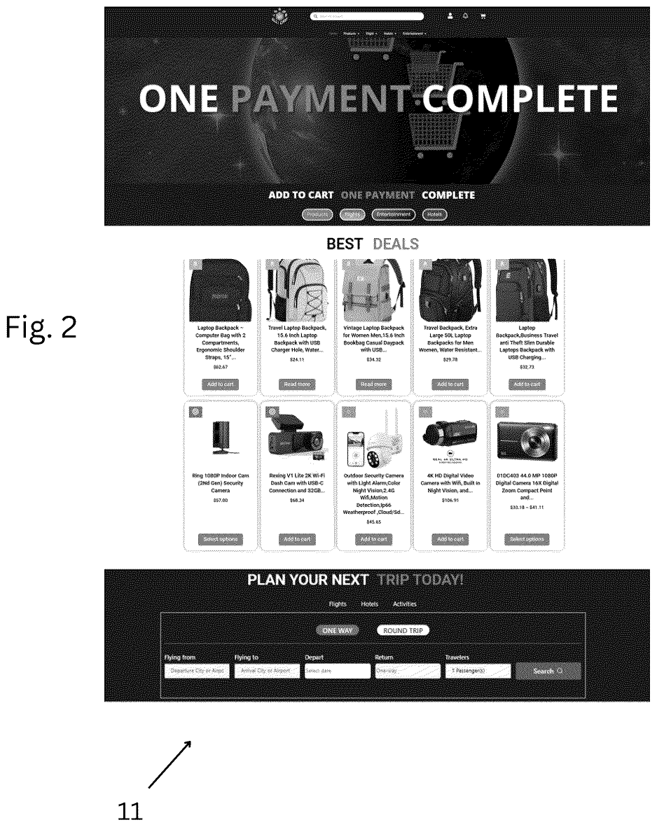

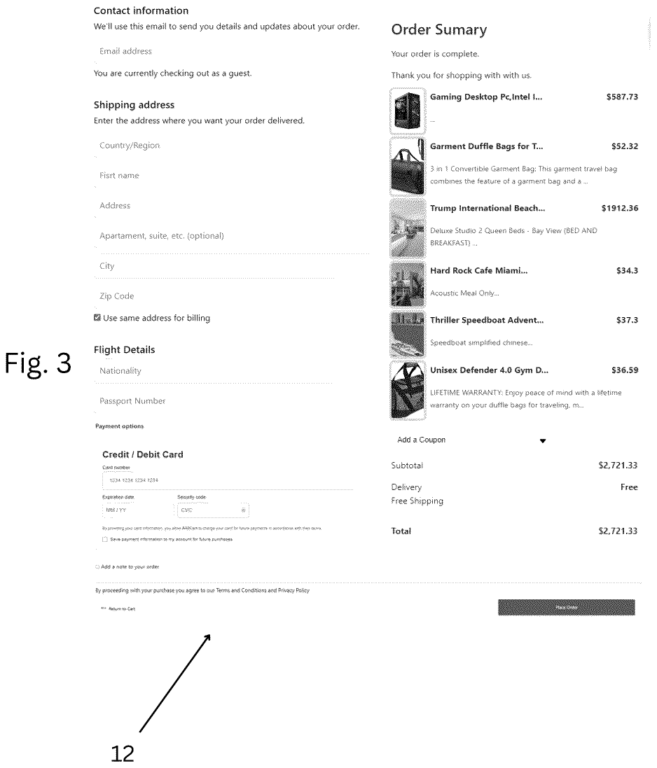

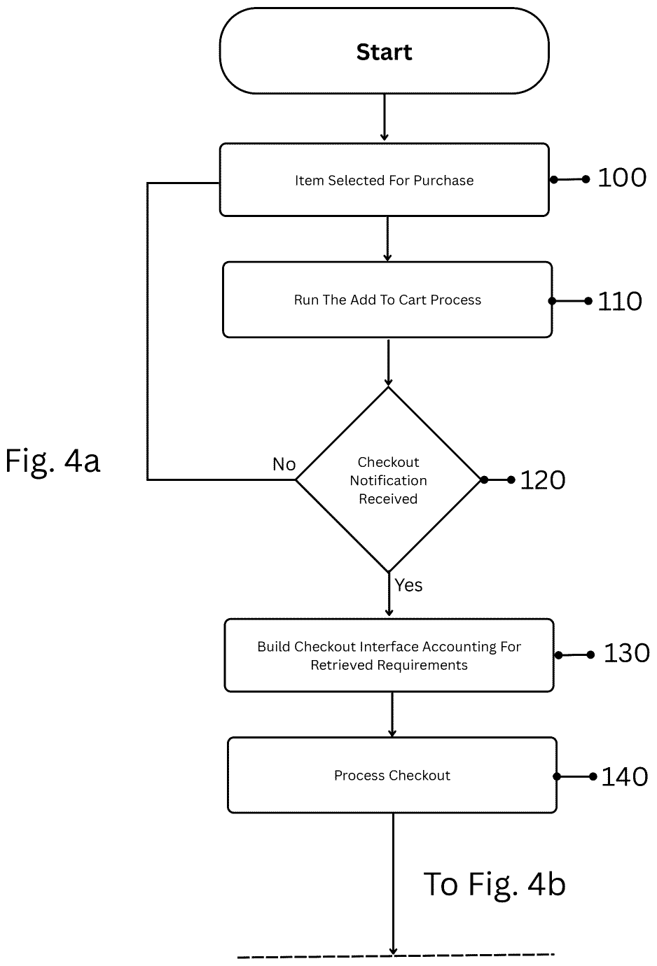

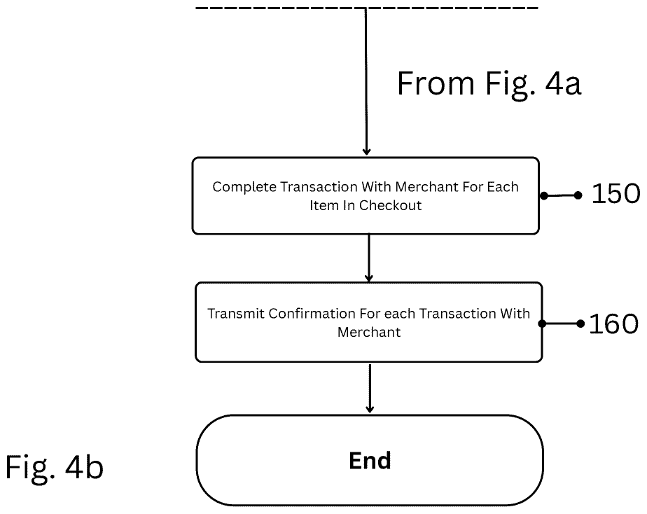

Referring now to FIGS. 2, 3, 4a and 4b, the checkout process of a unified shopping and checkout system for a multiple merchant e-commerce platform may begin when an item is selected for purchase at step 100. Embodiments of the unified shopping and checkout system for a multiple merchant e-commerce platform may allow items to be searched, viewed, and ultimately selected for purchase through a combined shopping interface 11 which may be made accessible by the platform server and may be accessed by a client device of the Internet. It is contemplated that the items which are available to be searched, viewed, and purchased on the combined shopping interface 11 are items which may be offered by sellers who have made their products or bookings available as discussed above.

Once an item is selected for purchase, a cart building engine in the platform server runs an add to cart process at step 110. The add to cart process may include determining if the item is a product or a live booking, identifying the information required by the seller of the item selected to purchase the item, and designating the item as transaction ready. For product listings, designating the item as transaction ready may include verifying the relevant merchant and price, checking inventory levels with the merchant and attempting to place a cart hold on the item on the merchant server, creating a unique purchase identifier and purchase ticket, thereby placing the item in a checkout queue, and causing the item to appear in a cart interface that is visible to the user. For live bookings, designating the item as transaction ready may include verifying the relevant merchant and price, confirming the continuing availability of the booking with the merchant and attempting to place a cart hold on the item on the merchant server, creating a temporary product which represents and corresponds to the live booking in the platform server, creating a unique purchase identifier and purchase ticket for the temporary product, adding an exclusivity timer and synchronizing it with any timer in use by the live booking merchant that is connected to the cart hold, placing the item in a checkout queue, and causing the item to appear in a cart interface that is visible to the user.

It is appreciated that the reason distinct processes are necessary for products and live bookings is that typical live engines only allow users the ability to “Book Now,” restricting their ability to also allow the purchase of products. For example if a user wanted to book a hotel and purchase a suitcase, historically, they would need to book the hotel first, then proceed to another site to complete the suitcase purchase. The reason both cannot be added to one cart is because one is a live booking while the other is a product. Unfortunately, having to make two different purchases, on two different platforms, increases the risk to the user that their information could be stolen or subsequently obtained illicitly through a hack.

The cart building engine uses the add to cart process to solve this limitation because it extracts all the information needed to complete a purchase from a live booking engine and automatically creates a temporary product within the combined shopping interface. Through the use of the temporary product, instead of having to complete the live booking immediately, a user can add it to their cart and proceed shopping, with plans to complete the booking later. It is contemplated that by using an individual frame for different products on one hand and for different live booking engines on the other, the cart building engine can streamline the purchasing process.

It is appreciated that in order for the add to cart process to be performed, the cart building engine must first identify the seller of the item. This identification may be done by identifying which merchant server is associated with listing the item that was selected for purchase and then confirming what seller is associated with that merchant server. Then, through the stock synchronizing interface or live booking synchronizing interface the platform server then can specify to the merchant server the item selected for purchase and then submit a query to the merchant server to confirm the things needed for the add to cart process, including availability, price, and the information is required to complete a purchase of the item.

It is appreciated that the information required to complete a transaction may vary depending on the nature of the item desired to be purchased. For example, if an item like a school backpack was selected, all that may be required from an information standpoint is the name and address of the user who has selected the item for purchase. On the other hand, if an item like an airline ticket was desired to be purchased, much more information may be required.

It is contemplated that until a user seeks to initiate checkout, the user may iterate through steps 100 and 110 until they have selected all of the items they wish to purchase. Advantageously, because all of the information needed to complete a transaction for a selected item is retrieved when an item is selected for purchase, but the information itself is not yet required, if multiple items selected require some of the same information the platform server need not make the user enter the information more than once.

As a part of the step of creating a temporary product, it is contemplated that the cart building engine extracts all information related to completing the purchase of the item, including any exclusivity timer created by the live booking engine representing when any temporary hold of the live booking item will expire. The cart building engine may further create an internal timer which links with the exclusivity timer. The creation of the temporary product with an individual and unique identifier within the platform server functionally allows for the user to proceed with shopping with the understanding that the item is being held in their cart. Once all shopping is done, this also allows the user to complete one purchase for all items which may have been selected before and after the live booking item, and then, once the user complete the transaction with the platform server, for the platform server to initiate the completion of the purchase for the live booking merchant in real time.

If, while the user is chopping, the exclusivity timer runs out, the platform server may automatically delete the temporary product it created, removes the item from the user's cart, and then automatically attempt to re-add the item again (or the closest item remaining available) to their cart through the same process to restart the exclusivity timer.

Once a user has selected all of the items they wish to purchase, the user may initiate checkout through the combined shopping interface 11, causing the platform server to receive a notification that checkout is desired at step 120. Once this notification is received, the platform server builds a checkout interface 12 at step 130 which includes form boxes for retrieving each piece of information that was required to purchase each item that was selected for purchase. It is contemplated that the form boxes may allow for the entry of text or the upload of other forms of data such as photos (which could be of, for example, a passport or a driver's license).

Through the building of the checkout interface at step 130, the platform server may utilize one of a plurality of preprogrammed frames for each item to be purchased and utilize inputs from the cart building engine regarding what information is required to purchase each item to complete the frame for each item. Each frame may include specific information requirements which may be based on the nature of the purchase and/or a relevant merchant server. For example, a frame for a product may include spaces for address and billing information. Alternatively, when a user attempts to buy an airline ticket, the platform server may utilize a programmed flight frame that organizes the information needed to complete a flight transaction (i.e., in addition to an address and billing information, the flight frame may also require a driver's license number and/or passport number). Similarly, when adding a hotel, a hotel frame may require a driver's license. In this way, the use of frames ensures that once the user is ready to checkout the platform server can prompt for the entry of all needed information for each item sought to be purchased.

Through the checkout interface 12, the unified shopping and checkout system for a multiple merchant e-commerce platform may obtain through data entry all of the information needed to initiate a transaction with each merchant who is selling an item that a user has sought to purchase. This may also include information on the user's method of payment. Once this is all provided by the user, the platform server may process the checkout at step 140. When processing the checkout, the platform server may process a transaction charge to the user's method of payment for the entire amount needed to complete a transaction for all items purchased. The platform server may also create a ticket payload for an API transmission for each seller (by way of their associated merchant server) who is selling an item in the checkout that includes the item being purchased, the information required to complete the purchase, and data needed to initiate or confirm an electronic funds transfer for the amount required for the transaction.

It is contemplated that by allowing a user to enter into a single transaction for multiple items split across multiple suppliers & booking engines simultaneously, the user's privacy and protection from fraud may be minimized.

When the platform server processes the checkout, it may send a notification such as an email to the user confirming the same.

Once this payload is created, the platform server may then complete a transaction with each seller who was selling an item in the checkout at step 150. This step may include the platform server sending the API payload and receiving confirmation information from each merchant server so as to route the orders placed to the relevant merchant server. It also may be the platform server transmitting funds and processing payments to each merchant server (by way of an ETF to a digital wallet or other conventional means for specific product and live booking engine purchase. The platform server then may provide the user with a ship and tracking feature, which incorporates confirmations received from each relevant merchant server. The platform server may send a notification such as an email to the user at step 160 providing confirmation and shipping/delivery information as is pertinent.

It is contemplated that the platform server may allow for the initiation of purchases and the monitoring of transactions through a user account. From a user account interface, the user may be able to see their products ordered as well as flights, hotels, and entertainment booked. The user account interface may also separate transactions by vendors and purchases from recently viewed items. In addition, the user account interface may include all of a user's tracking information posted into their account. The user account interface may also include a notification system which operates to notify a user immediately through email for future reference/receipt/tracking if anything happens through the user account interface. Advantageously, this provides the users with an email receipt of their successful purchases for their records and all is available at the tip of their fingers through the user account interface.

Advantageously, the unified shopping and checkout system for a multiple merchant e-commerce platform provides a multi-supplier drop shipping platform. As discussed above, it leverages an integrated order management and API system that can handle a plurality of distinct merchants and interact with their servers. In this regard, the system and method can advantageously handle supplier onboarding and management, product catalog integration (with each supplier's products uniquely listed), order routing and fulfillment with orders placed on the platform being routed to the correct supplier(s) for processing), inventory and stock management (with inventory levels synced between the platform and the suppliers), shipping and tracking (with customers provided with shipping and tracking details from various suppliers), and a unified checkout experience (which allows customers to place a single order that can be split across multiple suppliers).

Embodiments of the unified shopping and checkout system for a multiple merchant e-commerce platform may utilize a home page with an optimized search engine which will be able to travel and project all various sites which are fed to program. Similar to when searching “Refrigerator” in conventional search engines, this prompt would simply show you different refrigerators across different competitors who are in the system. That said, the system would allow for monitoring and control of which sites are showcased. This can avoid the problem created when merchants buy ads or engage in deceptive SEO practices in order to be listed highly on conventional search engines. The system described here would include not only reliability, but also include who really has the best deals in the platform for what clients are looking for (for example, one merchant may sell an item for $800 with another showing it for $680). Thus, users can see the best pricing from a known vendor every time, making sure they get the best deal available at the moment while saving you a bunch of time.

As discussed above, embodiments of the unified shopping and checkout system for a multiple merchant e-commerce platform may be powered with an integrated order management and API system to simply store a guide to allow plug & play checkout technologies. The API technology could follow our guides on what required fields are missing prior to completing a transaction with certain vendors. Not all transactions would take the same information, so the API is housed in the shopping cart. As users add different items from different stores one or more APIs may be monitoring the additions to the cart storing them so as to know in advance what would be required to complete the order.

Once items desired have all been added into a cart, the order details can be reviewed and the user can proceed to press a checkout button. This may then load a landing page which would display all required fields/uploads required at moment to complete the transactions (for all items in the transaction). Once all fields are completed & payment has been held or completed, the user's work is done and their transaction has been initiated and funded.

After the order has been completed comes a second stage. In this, an AI module may provide to each seller all the information required to complete a desired transaction with that seller and initiate the transmission of the funds for it. A unique landing page may be opened for each seller with an item added to the cart (this is where AI would store all the items/products/trips for each individual store) then the AI would go into the system and complete each transaction for the client separately, separated by landing page created for each store in receipt. Once this is complete, the user would receive individual emails seconds/minutes apart depending on the progress of the order processing in the system.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A unified shopping and checkout mechanism system, comprising:
an administrator computer system accessible over a computer network, wherein the administrator computer system is configured to:
provide a shopping interface which includes a listing containing a plurality of product listing purchasable items available to purchase and a plurality of live booking purchasable items available to purchase, with the plurality of product listing purchasable items and the plurality of live booking purchasable items being retrieved from a plurality of merchant computer systems;
receive from a remote client device a product selection defined by a desired product listing purchasable item among the plurality of product listing purchasable items and perform an add to cart process upon receipt of the product selection;
receive from the remote client device a booking selection defined by a desired booking purchasable item among the plurality of live booking purchasable items and perform the add to cart process upon receipt of the booking selection;
wherein the add to cart process for the product selection includes at least identifying a corresponding product merchant computer system among the plurality of merchant computer systems on which the product selection is offered, identifying product purchaser user information for the product selection required by the corresponding product merchant computer system, attempting to place a checkout hold on the product selection in the corresponding product merchant computer system, and placing the product selection in a checkout queue;
wherein the add to cart process for the booking selection includes at least identifying a corresponding booking merchant computer system among the plurality of merchant computer systems on which the booking selection is offered, identifying booking purchaser user information for the booking selection required by the corresponding booking merchant computer system, creating a temporary substitute product selection that is associated with the booking selection, placing the substitute product selection in the checkout queue and by doing so, attempting to place a checkout hold on the booking selection in the corresponding booking merchant computer system; and
subsequent to the add to cart process for the booking selection, create a checkout interface related to the checkout queue, wherein the checkout interface enables the entry by the remote client device of the product purchaser user information and the booking purchaser user information and the initiation by the remote client device of a unified payment for the product selection in the checkout queue and the booking selection associated with the substitute product selection in the checkout queue.

2. The unified shopping and checkout mechanism system of claim 1, wherein upon the remote client device providing the product purchaser user information and the booking purchaser user information and initiating the payment, the administrator computer system is configured to complete a product transaction with the corresponding product merchant computer system for the product selection and complete a booking transaction with the booking selection in the corresponding booking merchant computer system for the booking selection associated with the substitute product selection in the checkout queue.

3. The unified shopping and checkout mechanism system of claim 2, wherein completing the product transaction includes providing the product purchaser user information and a product payment related to the product selection to the corresponding product merchant computer system, with the product payment related to the product selection accounting for a first portion of the unified payment.

4. The unified shopping and checkout mechanism system of claim 2, wherein completing the booking transaction includes providing the booking purchaser user information and a booking payment related to the booking selection to the corresponding booking merchant computer system, with the booking payment related to the booking selection accounting for a second portion of the unified payment.

5. The unified shopping and checkout mechanism system of claim 2, wherein subsequent to completing the product transaction and completing the booking transaction, the administrator computer system is configured to transmit transaction information to the remote client device.

6. The unified shopping and checkout mechanism system of claim 1, wherein the listing containing the plurality of product listing purchasable items available to purchase is synchronized across a first group of merchant computer systems among the plurality of merchant computer systems.

7. The unified shopping and checkout mechanism system of claim 1, wherein the listing containing the plurality of live booking purchasable items available to purchase is synchronized across a second group of merchant computer systems among the plurality of merchant computer systems.

8. The unified shopping and checkout mechanism system of claim 1, wherein creating the substitute product selection includes adding an internal timer that is related to checkout hold on the booking selection in the corresponding booking merchant computer system.

9. The unified shopping and checkout mechanism system of claim 1, wherein whenever the internal timer expires, the administrator computer system is configured to remove the substitute product selection from the checkout queue and then perform the add to cart process for the booking selection again.

10. The unified shopping and checkout mechanism system of claim 1, wherein the checkout interface additionally requires the entry by the remote client device of product purchaser user information.

11. A unified shopping and checkout mechanism system, comprising:
an administrator computer system accessible over a computer network, wherein the administrator computer system is configured to:
provide a shopping interface which includes a listing containing a plurality of product listing purchasable items available to purchase and a plurality of live booking purchasable items available to purchase, with the plurality of product listing purchasable items and the plurality of live booking purchasable items being retrieved from a plurality of merchant computer systems;
receive from a remote client device a product selection defined by a desired product listing purchasable item among the plurality of product listing purchasable items and perform an add to cart process upon receipt of the product selection;
receive from the remote client device a booking selection defined by a desired booking purchasable item among the plurality of live booking purchasable items and perform the add to cart process upon receipt of the booking selection;
wherein the add to cart process for the product selection includes at least identifying a corresponding product merchant computer system among the plurality of merchant computer systems on which the product selection is offered, identifying product purchaser user information for the product selection required by the corresponding product merchant computer system, attempting to place a checkout hold on the product selection in the corresponding product merchant computer system, and placing the product selection in a checkout queue;
wherein the add to cart process for the booking selection includes at least identifying a corresponding booking merchant computer system among the plurality of merchant computer systems on which the booking selection is offered, identifying booking purchaser user information for the booking selection required by the corresponding booking merchant computer system, creating a temporary substitute product selection that is associated with the booking selection, placing the substitute product selection in the checkout queue and by doing so, attempting to place a checkout hold on the booking selection in the corresponding booking merchant computer system;
subsequent to the add to cart process for the booking selection, create a checkout interface related to the checkout queue, wherein the checkout interface enables the entry by the remote client device of the product purchaser user information and the booking purchaser user information and the initiation by the remote client device of a unified payment for the product selection in the checkout queue and the booking selection associated with the substitute product selection in the checkout queue;
wherein creating the substitute product selection includes adding an internal timer that is related to checkout hold on the booking selection in the corresponding booking merchant computer system; and
upon the remote client device providing the product purchaser user information and the booking purchaser user information and initiating the payment, complete a product transaction with the corresponding product merchant computer system for the product selection and complete a booking transaction with the booking selection in the corresponding booking merchant computer system for the booking selection associated with the substitute product selection in the checkout queue.

12. The unified shopping and checkout mechanism system of claim 11, wherein completing the product transaction includes providing the product purchaser user information and a product payment related to the product selection to the corresponding product merchant computer system, with the product payment related to the product selection accounting for a first portion of the unified payment.

13. The unified shopping and checkout mechanism system of claim 11, wherein completing the booking transaction includes providing the booking purchaser user information and a booking payment related to the booking selection to the corresponding booking merchant computer system, with the booking payment related to the booking selection accounting for a second portion of the unified payment.

14. The unified shopping and checkout mechanism system of claim 11, wherein subsequent to completing the product transaction and completing the booking transaction, the administrator computer system is configured to transmit transaction information to the remote client device.

15. The unified shopping and checkout mechanism system of claim 11, wherein the listing containing the plurality of product listing purchasable items available to purchase is synchronized across a first group of merchant computer systems among the plurality of merchant computer systems.

16. The unified shopping and checkout mechanism system of claim 11, wherein the listing containing the plurality of live booking purchasable items available to purchase is synchronized across a second group of merchant computer systems among the plurality of merchant computer systems.

17. The unified shopping and checkout mechanism system of claim 11, wherein whenever the internal timer expires, the administrator computer system is configured to remove the substitute product selection from the checkout queue and then perform the add to cart process for the booking selection again.

18. The unified shopping and checkout mechanism system of claim 11, wherein the checkout interface additionally requires the entry by the remote client device of product purchaser user information.

19. A unified shopping and checkout mechanism method, comprising:
providing, by an administrator computer system accessible over a computer network, a shopping interface which includes a listing containing a plurality of product listing purchasable items available to purchase and a plurality of live booking purchasable items available to purchase, with the plurality of product listing purchasable items and the plurality of live booking purchasable items being retrieved from a plurality of merchant computer systems;
receiving, by an administrator computer system, a product selection defined by a desired product listing purchasable item among the plurality of product listing purchasable items from a remote client device and performing an add to cart process upon receipt of the product selection, wherein the add to cart process for the product selection includes at least identifying a corresponding product merchant computer system among the plurality of merchant computer systems on which the product selection is offered, identifying product purchaser user information for the product selection required by the corresponding product merchant computer system, attempting to place a checkout hold on the product selection in the corresponding product merchant computer system, and placing the product selection in a checkout queue;
receiving, by an administrator computer system, a booking selection defined by a desired booking purchasable item among the plurality of live booking purchasable items from the remote client device and performing the add to cart process upon receipt of the booking selection, wherein the add to cart process for the booking selection includes at least identifying a corresponding booking merchant computer system among the plurality of merchant computer systems on which the booking selection is offered, identifying booking purchaser user information for the booking selection required by the corresponding booking merchant computer system, creating a temporary substitute product selection that is associated with the booking selection, placing the substitute product selection in the checkout queue and by doing so, attempting to place a checkout hold on the booking selection in the corresponding booking merchant computer system;
following the performing of the add to cart process for the booking selection, creating, by an administrator computer system, a checkout interface related to the checkout queue, wherein the checkout interface enables the entry by the remote client device of the product purchaser user information and the booking purchaser user information and the initiation by the remote client device of a unified payment for the product selection in the checkout queue and the booking selection associated with the substitute product selection in the checkout queue;
wherein creating the substitute product selection includes adding an internal timer that is related to checkout hold on the booking selection in the corresponding booking merchant computer system; and
following the remote client device providing the product purchaser user information and the booking purchaser user information and initiating the payment, completing, by an administrator computer system, a product transaction with the corresponding product merchant computer system for the product selection and a booking transaction with the booking selection in the corresponding booking merchant computer system for the booking selection associated with the substitute product selection in the checkout queue.

20. The method of claim 19, wherein:
the step of completing the product transaction includes providing the product purchaser user information and a product payment related to the product selection to the corresponding product merchant computer system, with the product payment related to the product selection accounting for a first portion of the unified payment; and
the step of completing the booking transaction includes providing the booking purchaser user information and a booking payment related to the booking selection to the corresponding booking merchant computer system, with the booking payment related to the booking selection accounting for a second portion of the unified payment.
